(19) United States
(12) Patent Application Publication
(10) Pub. No.: US 2007/0272771 A1
(43) Pub. Date: Nov. 29, 2007

(54) Fuel Injection Valve For Internal Combustion Engine

(75) Inventors: Hiroaki Nozaki, Higashimatsuyama-shi (JP); Kiyoshi Matsuzaki, Higashimatsuyama-shi (JP)

Correspondence Address: CONNOLLY BOVE LODGE & HUTZ LLP, 1875 EYE STREET, N.W., SUITE 1100, WASHINGTON, DC, 20036, US

(73) Assignee: Bosch Coporation, Tokyo (JP)

(21) Appl. No.: 10/572,550

(22) PCT Filed: Sep. 7, 2004
(86) PCT No.: PCT/JP04/13295

§ 371 Date: Jan. 31, 2007

(30) Foreign Application Priority Data
Sep. 19, 2003 (JP) 2003-327214

(51) Int. Cl. F02M 61/16

(52) U.S. Cl. 239/533.12

(57) ABSTRACT

In order to ensure that operation does not become unstable even when a wax component included in fuel solidifies, in a fuel injection valve (1) comprising a nozzle (3) fixed to a leading end portion of a nozzle holder (2), with the nozzle (3) being configured such that a nozzle needle (32) inserted into a guide hole (33) inside a nozzle body (31) is guided by the guide hole (33) and moves in an axial direction to open/close an injection hole (35), a tapered portion (33B) that widens toward the nozzle holder (2) is disposed in the guide hole (33). Thus, when the component included in the fuel solidifies, the solidified matter can be speedily discharged from a gap (G) serving as a fuel leak passage formed between the nozzle needle (32) and the guide hole (33).

### TECHNICAL FIELD

The present invention relates to a fuel injection valve for directly injecting/supplying fuel to the inside of a cylinder of an internal combustion engine.

### BACKGROUND ART

As a fuel injection valve for directly injecting/supplying fuel to the inside of a cylinder of an internal combustion engine such as in the Common Rail System, a fuel injection valve of the type disclosed in JP-A-7-310621, for example, is known. This fuel injection valve is configured such that an electromagnetic valve is powered and opened so that a control chamber inside the body of the fuel injection valve becomes communicated with a low-pressure portion, whereby the back pressure of a valve piston is removed, a nozzle needle is lifted, fuel injection is initiated, the powering of the electromagnetic valve is stopped after the elapse of a predetermined amount of time, and the communicated state between the control chamber and the low-pressure portion is released, whereby predetermined back pressure acts on the valve piston, the nozzle needle is pushed down, and fuel injection is terminated.

Incidentally, in regions of extremely low temperature, wax is mixed into the fuel in order to ensure that the aforementioned smooth operation of the fuel injection valve can be secured even at a low temperature. Consequently, there is the problem that, depending on the running condition of the engine, as when the engine is started in a low temperature atmosphere such as −20° C. or below, the wax mixed into the fuel is deposited in portions of the fuel injection valve and causes various problems. Particularly when the wax is deposited in a fuel leak passage for allowing the fuel to escape from the high-pressure side to the low-pressure side, there is a tendency for the fuel to become unable to pass therethrough, and for the operation of the fuel injection valve, and particularly the operation of the nozzle needle, to become unstable. As a result, there is the problem that this triggers drawbacks such as the fuel injection operation of the fuel injection valve becoming unstable.

It is an object of the present invention to provide a fuel injection valve for an internal combustion engine that can solve the aforementioned problem in the prior art.

It is another object of the present invention to provide a fuel injection valve for an internal combustion engine that can speedily discharge solidified matter when solidified matter arises in the fuel.

### DISCLOSURE OF THE INVENTION

In the present invention, a nozzle needle and/or its guide hole are/is tapered in a fuel injection valve for an internal combustion engine, so when a component included in the fuel solidifies, the solidified matter is speedily discharged from a gap serving as a fuel leak passage formed between the nozzle needle and the guide hole.

According to the present invention, there is proposed a fuel injection valve for an internal combustion engine comprising a nozzle fixed to a leading end portion of a nozzle holder, with the nozzle being configured such that a nozzle needle inserted into a guide hole inside a nozzle body is guided by the guide hole and moves in an axial direction to open/close an injection hole, wherein at least part of a gap formed between the nozzle needle and the guide hole has a tapered shape that widens toward the nozzle holder. The angle of the tapered portion can be appropriately determined.

The nozzle needle is supported and guided in the guide hole such that the nozzle needle is movable in an axial direction inside the guide hole. The gap between the nozzle needle and the guide hole is extremely narrow, and high-pressure fuel of a high-pressure portion of the leading end of the nozzle needle slightly leaks through the gap to a low-pressure portion at the nozzle holder side. At least part of the gap is tapered, and the gap has a form including a portion that widens like a skirt from the high-pressure portion to the fuel low-pressure portion. As a result, the width of the gap becomes larger closer to the low-pressure portion. Consequently, when mixed matter such as wax included in the leak fuel solidifies and is deposited inside the gap when the engine is running at a low temperature, the solidified matter inside the gap is sent to the low-pressure side by the movement of the piston of the nozzle needle, so that the solidified matter does not remain inside the gap. For this reason, when fuel having wax mixed therein is used and the fuel injection valve is operated, stable operation can be expected even at a low temperature.

### BRIEF DESCRIPTION OF THE DRAWINGS

FIG. 1 is a cross-sectional view showing an embodiment of a fuel injection valve for an internal combustion engine according to the present invention.

FIG. 2 is an enlarged cross-sectional view showing the relevant portions of FIG. 1.

FIG. 3 is an enlarged cross-sectional view of the relevant portions of a modification of the fuel injection valve for an internal combustion engine shown in FIG. 1.

FIG. 4 is an enlarged cross-sectional view of the relevant portions of a modification of a nozzle shown in FIG. 2.

### BEST MODE FOR IMPLEMENTING THE INVENTION

The present invention will now be described in greater detail in accordance with the attached drawings.

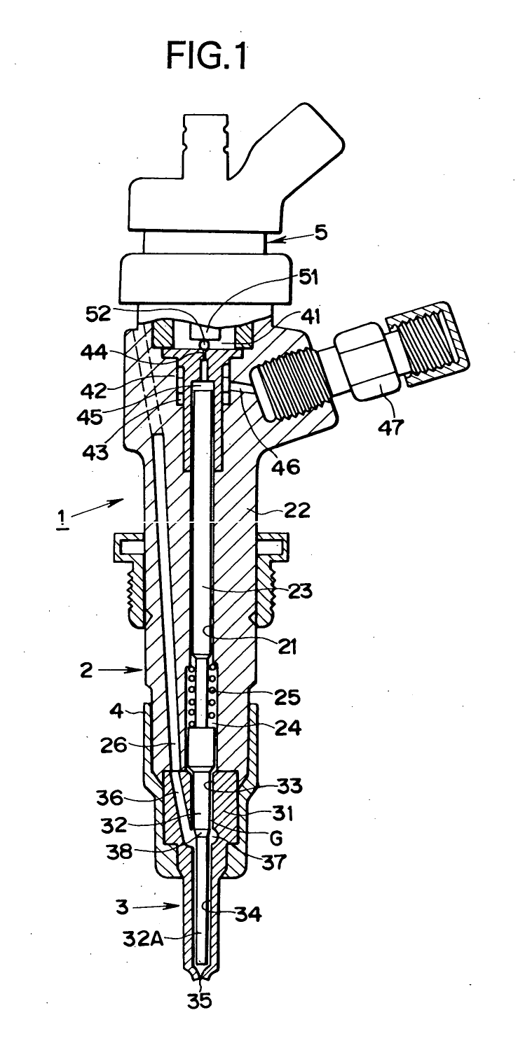

FIG. 1 is a cross-sectional view showing an example of an embodiment of a fuel injection valve according to the present invention. That which is represented by reference numeral 1 is a fuel injection valve for an internal combustion engine used in the Common Rail System for injecting/supplying fuel to a diesel internal combustion engine. The fuel injection valve 1 is attached to a cylinder of an unillustrated diesel internal combustion engine, is for directly injecting/supplying, to the inside of the cylinder and at a required timing, just the required amount of high-pressure fuel supplied from an unillustrated common rail, and comprises a nozzle 3 fixed to the leading end of a nozzle holder 2 with a retaining nut 4. An electromagnetic valve 5 is disposed on a trailing end of the nozzle holder 2.

The nozzle holder 2 includes a hollow body 22 in which a guide hole 21 is formed in the axial direction of the hollow body 22, and a pressure pin 23 is disposed inside the guide hole 21 such that the pressure pin 23 is movable by the guide hole 21 in the axial direction of the guide hole 21. An elastic spring 25 is housed inside a spring chamber 24 of the hollow body 22, and a later-described nozzle needle 32 is elastically urged by the elastic spring 25 in the direction of an injection hole 35. That which is represented by reference numeral 26 is a passage disposed inside the hollow body 22 in order to supply the high-pressure fuel from the unillustrated common rail to the nozzle 3.

The nozzle 3 includes a nozzle body 31 and the nozzle needle 32. The nozzle needle 32 is supported and guided, such that it is movable in its axial direction, by a guide hole 33 formed coaxially inside the nozzle body 31. A leading end portion 32A of the nozzle needle 32 extends inside a cylinder portion 34 disposed inside the nozzle body 31 in line with the guide hole 33, and the leading end of the nozzle needle 32 moves as a valve element that opens/closes the injection hole 35.

Consequently, when the nozzle needle 32 is retained in the position where it closes the injection hole 35, fuel is not injected from the fuel injection valve 1. In contrast, when the nozzle needle 32 withdraws and is retained in the position where it opens the injection hole 35, fuel is injected from the fuel injection valve 1.

An oil pool 37 that stores the high-pressure fuel introduced thereto from the passage 26 via a passage 36 is formed inside the nozzle body 31. A tapered portion 38 for causing force to act in a direction where the nozzle needle 32 is moved away from the injection hole 35 due to the pressure of the high-pressure fuel inside the oil pool 37 is formed on the nozzle needle 32.

A head 42, in which a drain chamber 41 extending coaxially with the guide hole 21 in the axial direction of the hollow body 22 is formed facing down, is formed in a trailing end portion of the hollow body 22. A control chamber 45 that is communicated with a supply pathway 43 in the radial direction and a drain pathway 44 in the axial direction is formed in the head 42. The supply pathway 43 is communicated with an intake member 47 via a radial-direction pathway 46 inside the hollow body 22, and a bottom portion of the control chamber 45 is formed by an upper end surface of the pressure pin 23.

A ball 52 that works as a valve element is fixed to an armature 51 of the electromagnetic valve 5. The armature 51 is configured such that it is pushed down in the direction of the nozzle 3 by the force of an unillustrated valve spring, whereby the ball 52 is pushed against an open end of the drain pathway 44 to block off the drain pathway 44. However, when the electromagnetic valve 5 is urged, the armature 51 moves in the direction away from the head 42 counter to the force of the valve spring, whereby the ball 52 moves away from the open end of the drain pathway 44, and the drain pathway 44 becomes communicated with the drain chamber 41.

Consequently, when the electromagnetic valve 5 is not being powered, the open end of the drain pathway 44 is blocked off by the ball 52, whereby the control chamber 45 is filled with the high-pressure fuel. Thus, the nozzle needle 32 closes the injection hole 35 due to the pressure pin 23, and fuel injection is not conducted. When the electromagnetic valve 5 is powered, the ball 52 moves away from the open end of the drain pathway 44, the high-pressure fuel inside the control chamber 45 escapes to the fuel low-pressure portion, and the pressure inside the control chamber 45 drops, whereby fuel injection is conducted. When the power to the electromagnetic valve 5 is cut off, the nozzle needle 32 is again returned to the position where it closes the injection hole 35, and fuel injection ends. It will be noted that because the act of fuel injection from the nozzle 3 being carried out by controlling the power of the electromagnetic valve 5 as described above is itself known, further detailed description thereof will be omitted.

A gap G between the nozzle needle 32 and the guide hole 33 of the nozzle body 31 is an extremely slight gap such that it is substantially oil-tight. However, the pressure of the fuel stored in the oil pool 37 is extremely high, and the high-pressure fuel slightly leaks to the fuel low-pressure side of the nozzle holder 2 through the gap G. If a wax component is mixed into the fuel, the tendency arises for the wax component to be deposited and solidify in the gap G, particularly when the fuel injection valve 1 is operating at a low temperature, which causes the fuel injection valve 1 to operate defectively.

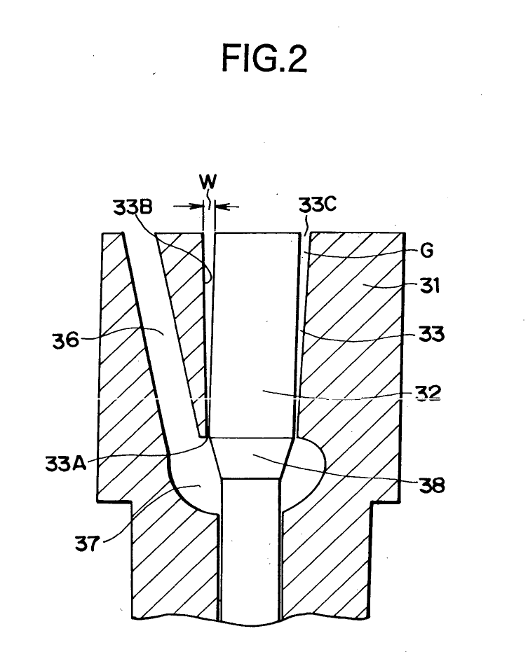

FIG. 2 is an enlarged view of the relevant portions of FIG. 1. As shown in FIG. 2, in the fuel injection valve 1, at least part of the gap G formed between the nozzle needle 32 and the guide hole 33 has a tapered shape that widens toward the nozzle holder 2 in order to ensure that the aforementioned defective operation does not occur.

In the present embodiment, the guide hole 33 is formed such that it includes a tapered portion 33B that widens from one end portion 33A at the oil pool 37 side toward the nozzle holder 2, so that the gap G has the tapered shape that widens toward the nozzle holder 2. As a result, a width W of the gap G is extremely narrow at the one end portion 33A and linearly increases toward another end portion 33C of the guide hole 33. That is, the gap G widens like a skirt from the fuel high-pressure portion to the fuel low-pressure portion.

Because the guide hole 33 is configured as described above, the width W of the gap G in the vicinity of the one end portion 33A of the guide hole 33 is small, whereby the required oil-tightness can be maintained. Additionally, because the gap G widens like a skirt from the fuel high-pressure portion to the fuel low-pressure portion, when, for example, the wax component in fuel slightly leaking from the oil pool 37 to the guide hole 33 is deposited and solidifies when the fuel injection valve 1 is operating at a low temperature, the solidified matter can easily be moved in the direction of the other end portion 33C of the gap G (in the direction of the nozzle holder 2) and discharged to the low-pressure portion of the nozzle holder 2.

Consequently, there is not the drawback where the solidified wax component remains inside the gap G, hinders the smooth operation of the nozzle holder 2, and causes the fuel injection operation to become unstable, as has conventionally been the case. As a result, when fuel having wax mixed therein is used and the fuel injection valve is operated, stable operation can be expected even at a low temperature.

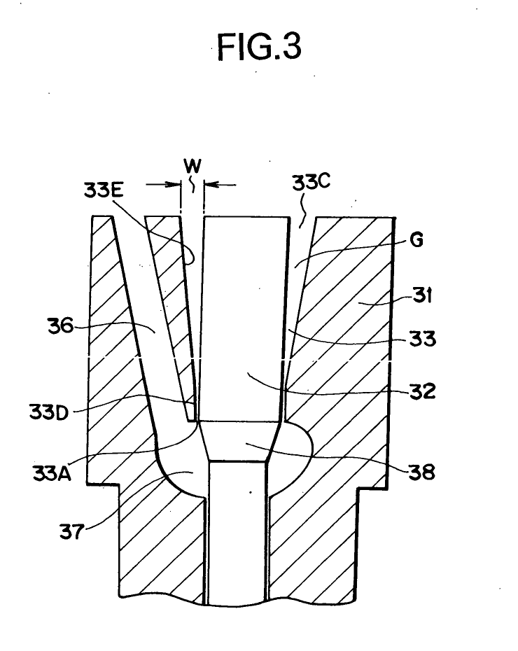

FIG. 3 is a diagram for describing a modification of the tapered portion of the guide hole 33. In the example shown in FIG. 2, the tapered portion 33B is disposed across the entire guide hole 33, but in the example shown in FIG. 3, the tapered portion 33B is disposed on part of the guide hole 33. As a result, at least part of the gap G has a tapered shape that widens toward the nozzle holder 2.

That is, the vicinity of the one end portion 33A of the guide hole 33 serves as a non-tapered portion 33D where the width of the gap G is constant and narrow, and a tapered portion 33E corresponding to the tapered portion 33B is disposed only between the non-tapered portion 33D and the other end portion 33C.

According to this configuration, by disposing the non-tapered portion 33D, the advantage that the oil-tightness between the guide hole 33 and the nozzle needle 32 becomes higher is obtained in addition to the advantage according to the configuration of FIG. 2.

It will be noted that the tapered form of the tapered portions 33B and 33E in FIG. 2 and FIG. 3 are not limited to being linear and can also be optional tapered forms, such as curvilinear or a mixture of linear and curvilinear.

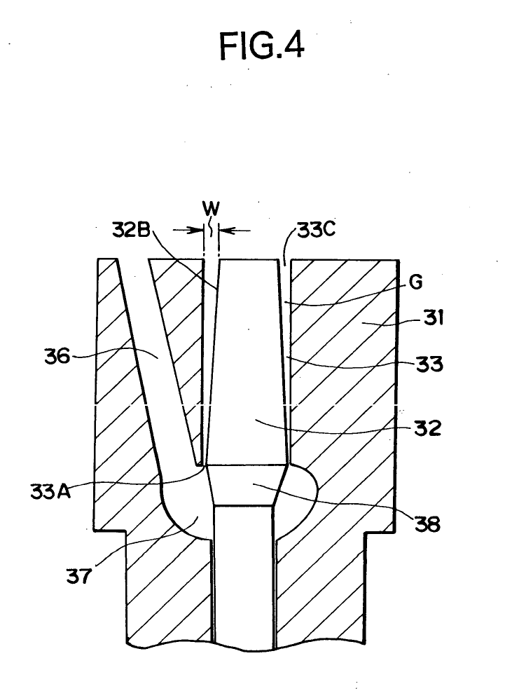

FIG. 4 is an enlarged cross-sectional view of the relevant portions of the nozzle 3 for describing another modification of the gap G shown in FIG. 2. In the configuration shown in FIG. 4, the gap G formed between the nozzle needle 32 and the guide hole 33 is given the tapered shape that widens toward the nozzle holder 2 as a result of a tapered portion 32B being disposed in the nozzle needle 32 rather than as a result of tapering the guide hole 33.

It will be noted with respect to FIG. 4 that by disposing the tapered portion 32B just on part of the nozzle needle 32, just part of the gap G can be tapered as shown in FIG. 3.

Moreover, at least part of the gap G formed between the nozzle needle 32 and the guide hole 33 can be given the tapered shape that widens toward the nozzle holder 2 by tapering both the guide hole 33 and the nozzle needle 32.

### INDUSTRIAL APPLICABILITY

According to the present invention, the invention is useful for the improvement of a fuel injection valve for an internal combustion engine that can maintain its operational stability, regardless of the running condition, when fuel having a heterogeneous component mixed therein is used and the fuel injection valve for an internal combustion engine is operated.

1. A fuel injection valve for an internal combustion engine comprising a nozzle fixed to a leading end portion of a nozzle holder, with the nozzle being configured such that a nozzle needle inserted into a guide hole inside a nozzle body is guided by the guide hole and moves in an axial direction to open/close an injection hole,
wherein at least part of a gap formed between the nozzle needle and the guide hole has a tapered shape that widens toward the nozzle holder.

2. The fuel injection valve for an internal combustion engine of claim 1, wherein the entire gap has a tapered shape that widens toward the nozzle holder.

3. The fuel injection valve for an internal combustion engine of claim 1, wherein the tapered shape of the gap is a linear tapered shape.

4. The fuel injection valve for an internal combustion engine of claim 2, wherein the tapered shape of the gap is a linear tapered shape.

5. The fuel injection valve for an internal combustion engine of claim 1, wherein the gap has a tapered shape as a result of a tapered portion being formed in at least the guide hole.

6. The fuel injection valve for an internal combustion engine of claim 1, wherein the gap has a tapered shape as a result of a tapered portion being formed in at least the nozzle needle.
